(19) United States
(12) Patent Application Publication
(10) Pub. No.: US 2025/0300250 A1
(43) Pub. Date: Sep. 25, 2025

(54) METHOD AND APPARATUS FOR CONTROLLING CHARGING AND DISCHARGING OF ENERGY STORAGE DEVICE

(71) Applicant: Electronics and Telecommunications Research Institute, Daejeon (KR)

(72) Inventor: Jaeik Jeong, Sejong-si (KR)

(21) Appl. No.: 19/055,438

(22) Filed: Feb. 17, 2025

(30) Foreign Application Priority Data
Mar. 19, 2024 (KR) 10-2024-0037738

(51) Int. Cl. H01M 10/44; H02J 7/00

(52) U.S. Cl. CPC H01M 10/44; H02J 7/0048; H02J 7/00712; H02J 7/007188

(57) ABSTRACT

Provided is a method. The method includes obtaining first information about an energy storage device and second information about an operating environment of the energy storage device, determining an amount of charge or an amount of discharge of the energy storage device from the first information and the second information based on a reinforcement learning model, charging or discharging the energy storage device based on the determined amount of charge or the determined amount of discharge, in which the reinforcement learning model is trained based on a first objective function that considers a possible charge-discharge range according to a real-time state of charge (SOC) of the energy storage device.

### CROSS-REFERENCE TO RELATED APPLICATIONS

This application claims the benefit of Korean Patent Application No. 10-2024-0037738, filed on Mar. 19, 2024, in the Korean Intellectual Property Office, the entire disclosure of which is incorporated herein by reference for all purposes.

### BACKGROUND

### 1. Field of the Invention

One or more embodiments relate to a method and apparatus for controlling charging and discharging of an energy storage device.

### 2. Description of the Related Art

The technology of controlling the charging and discharging of an energy storage device is key technology to efficiently manage energy in a power grid. An energy storage device may be charged based on the energy of a power grid or based on renewable energy such as solar or wind power. An energy storage device may supply charged energy to a power grid if needed. The discharging of an energy storage device may generally occur at the time point at which a power demand is high and/or when a power grid is short of energy. The time point of discharging and the amount of discharged energy may be optimized by considering the power demand prediction, the state of a power grid, the state of an energy storage device, and the like.

The latest energy storage system integrated with a power grid may monitor and analyze external environmental factors such as the state of a power grid and a power price in real time. Based on this information, the charging or discharging of an energy storage system is determined, and as a result, the profitability and efficiency of the energy storage system may be maximized.

This general theory shows that controlling the charging and/or discharging of an energy storage device is being realized by considering energy efficiency, stability, and sustainability.

The above information may be presented as the related art to help with the understanding of the disclosure. No arguments or decisions are made as to whether any of the above is applicable as a prior art related to the disclosure.

### SUMMARY

According to an aspect, there is provided a method including obtaining first information about an energy storage device and second information about an operating environment of the energy storage device, determining an amount of charge or an amount of discharge of the energy storage device from the first information and the second information based on a reinforcement learning model, charging or discharging the energy storage device based on the determined amount of charge or the determined amount of discharge, in which the reinforcement learning model is trained based on a first objective function that considers a possible charge-discharge range according to a real-time state of charge (SOC) of the energy storage device.

The first information may include the real-time SOC of the energy storage device, and the second information may include at least one of information about a real-time power price, information about a real-time power demand, or information about a real-time power supply in the operating environment.

The reinforcement learning model may include an actor neural network configured to receive the first information and the second information as states and configured to output a probability distribution of the amount of charge or the amount of discharge as policies for the states and a critic neural network configured to evaluate a value of the states.

The amount of charge or the amount of discharge may be obtained by averaging the policies and may correspond to an action of the reinforcement learning model.

The reinforcement learning model may be trained based on the first objective function, a second objective function for the actor neural network, and a third objective function for the critic neural network.

The first objective function may satisfy the following Equation,

$$f ( θ ) = {min ( {μ}_{θ} ( s ) - {a}_{s , min} , 0 )}^{2} + {min ( {a}_{s , max} - {μ}_{θ} ( s ) , 0 )}^{2}$$

in which μ_{θ}(s) denotes an action in a state s, α_{s,min} denotes a minimum value of possible actions in the state s, and α_{s,max} denotes a maximum value of the possible actions in the state s, wherein the action is the amount of charge or the amount of discharge.

According to another aspect, there is provided an electronic device including a processor and a memory configured to store instructions, in which the instructions, when executed by the processor, cause the electronic device to obtain first information about an energy storage device and second information about an operating environment of the energy storage device, determine an amount of charge or an amount of discharge of the energy storage device from the first information and the second information based on a reinforcement learning model, and charge or discharge the energy storage device based on the determined amount of charge or the determined amount of discharge, in which the reinforcement learning model is trained based on a first objective function that considers a possible charge-discharge range according to a real-time SOC of the energy storage device.

The first information may include the real-time SOC of the energy storage device, and the second information may include at least one of information about a real-time power price, information about a real-time power demand, or information about a real-time power supply in the operating environment.

The reinforcement learning model may include an actor neural network configured to receive the first information and the second information as states and configured to output a probability distribution of the amount of charge or the amount of discharge as policies for the states and a critic neural network configured to evaluate a value of the states.

The amount of charge or the amount of discharge may be obtained by averaging the policies and may correspond to an action of the reinforcement learning model.

The reinforcement learning model may be trained based on the first objective function, a second objective function for the actor neural network, and a third objective function for the critic neural network.

The first objective function may satisfy the following Equation,

$$f ( θ ) = {min ( {μ}_{θ} ( s ) - {a}_{s , min} , 0 )}^{2} + {min ( {a}_{s , max} - {μ}_{θ} ( s ) , 0 )}^{2}$$

in which μ_{θ}(s) denotes an action in a state s, α_{s,min} denotes a minimum value of possible actions in the state s, and α_{s,max} denotes a maximum value of the possible actions in the state s, wherein the action is the amount of charge or the amount of discharge.

According to still another aspect, there is provided a method including obtaining first information about an energy storage device and second information about an operating environment of the energy storage device, by inputting the first information and the second information to a reinforcement learning model as states, obtaining a probability distribution of an amount of charge or an amount of discharge of the energy storage device as policies for the states, obtaining an action for the states by determining the amount of charge or the amount of discharge of the energy storage device based on the policies, and based on a first objective function that considers a possible charge-discharge range according to a real-time SOC of the energy storage device, training the reinforcement learning model so that the determined amount of charge or the determined amount of discharge is located in the possible charge-discharge range.

The first information may include the real-time SOC of the energy storage device, and the second information may include at least one of information about a real-time power price, information about a real-time power demand, or information about a real-time power supply in the operating environment.

The training of the reinforcement learning model may include calculating a reward for the determined amount of charge or the determined amount of discharge based on the second information and calculating an objective function to train the reinforcement learning model based on the reward.

The reinforcement learning model may include an actor neural network configured to output the policies for the states and a critic neural network configured to evaluate a value of the states, in which the objective function may include the first objective function, a second objective function for the actor neural network, and a third objective function for the critic neural network.

The first objective function may satisfy the following Equation,

$$f ( θ ( = {min ( {μ}_{θ} ( s ) - {a}_{s , min} , 0 )}^{2} + {min ( {a}_{s , max} - {μ}_{θ} ( s ) , 0 )}^{2}$$

in which μ_{θ}(s) denotes an action in a state s, α_{s,min} denotes a minimum value of possible actions in the state s, α_{s,max} denotes a maximum value of the possible actions in the state s, wherein the action is the amount of charge or the amount of discharge.

The determined amount of charge or the determined amount of discharge may correspond to an average value of the policies.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an electronic device according to an embodiment;

FIG. 2 is a diagram illustrating a reinforcement learning model according to an embodiment;

FIG. 3 is a flowchart illustrating an operation of training a reinforcement learning model, according to an embodiment; and

FIG. 4 is a flowchart illustrating an operation of controlling an energy storage device based on a trained reinforcement learning model, according to an embodiment.

### DETAILED DESCRIPTION

The following detailed structural or functional description is provided as an example only and various alterations and modifications may be made to embodiments. Accordingly, the embodiments are not to be construed as limited to the disclosure and should be understood to include all changes, equivalents, or replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more of functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate one or more of central processing units (CPUs) within a device or a security multimedia card. In addition, “unit” may include one or more of processors.

Hereinafter, embodiments will be described in detail with reference to the accompanying drawings. When describing the embodiments with reference to the accompanying drawings, like reference numerals refer to like elements and a repeated description related thereto will be omitted.

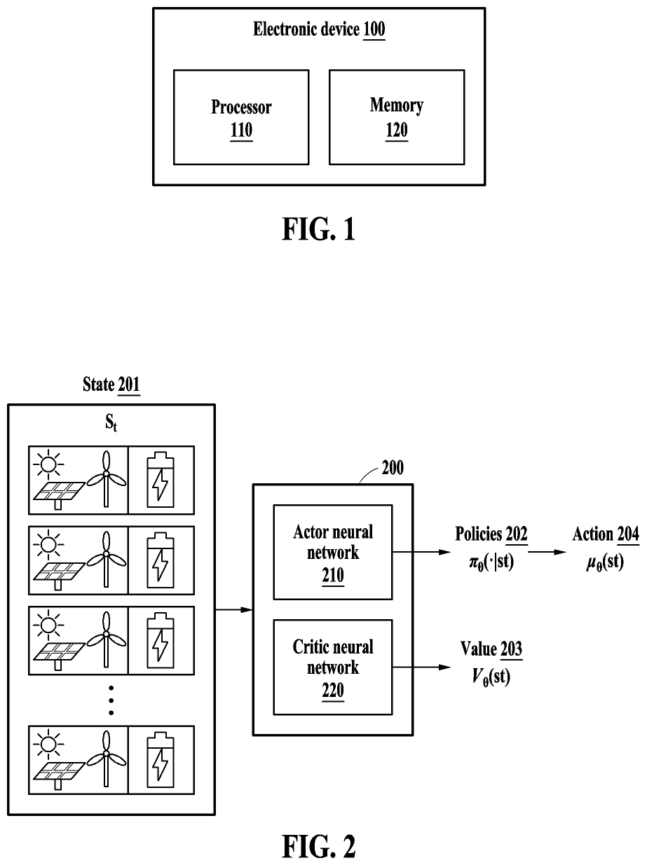

FIG. 1 is a block diagram illustrating an electronic device according to an embodiment.

Referring to FIG. 1, according to an embodiment, an electronic device 100 may control the charging and discharging of an energy storage device. The electronic device 100 may control the charging and discharging of the energy storage device by considering a real-time state of charge (SOC) of the energy storage device.

An optimization-based method may be used to control the charging and discharging of the energy storage device. The optimization-based method may use an objective function to optimize an operation of the energy storage device under a given constraint. Here, the constraint may include a possible charge-discharge range of the energy storage device. For example, when the SOC of the energy storage device is 75%, the possible charge-discharge range of the energy storage device may be between-25% and 75% (e.g., a positive number represents an amount of discharge and a negative number represents an amount of charge). Using a Lagrange multiplier method, the optimization-based method may easily obtain an optimal solution of the objective function even when a plurality of constraints exists. However, the optimization-based method may be difficult to use when there is an uncertain factor (e.g., renewable energy generation, energy demands, and energy prices) in a variable.

A reinforcement learning-based method may be used to control the charging and charging of the energy storage device. The reinforcement learning-based method may make an optimal decision when an uncertain factor exists as a variable (e.g., a situation in which an operating environment of the energy storage device is changed dynamically). In the reinforcement learning-based method, a discrete reinforcement learning-based method, such as a deep Q network (DQN) and Q learning, has been developed. The discrete reinforcement learning-based method may be used when an action space of reinforcement learning is discrete. Accordingly, the amount of charge or the amount of discharge may need to be discretized to use the discrete reinforcement learning-based method to control the charging and discharging of the energy storage device. For example, when the amount of charge or the amount of discharge is discretized in a unit of 5%, the amount of discharge may be determined among 5%, 10%, 15%, . . . , and the amount of charge may be determined among −5%, −10%, −15%, . . . . However, the optimal amount of charge or discharge of energy (e.g., an optimal solution) that considers the operating environment of the energy storage device may exist between 5% and 10%, and discrete reinforcement learning may not select a value therebetween. Here, the amount of charge or the amount of discharge may be discretized into an extremely small unit (e.g., 0.1%) for more precise control, but in this case, the action space becomes too wide, which may cause instability in training. Accordingly, it may be difficult for the discrete reinforcement learning-based method to continuously control the charging and discharging of the energy storage device.

According to an embodiment, the electronic device 100 may continuously control the charging and discharging of the energy storage device. The electronic device 100 may use the objective function (e.g., a first objective function) that considers the possible charge-discharge range according to the real-time SOC of the energy storage device. For example, when the real-time SOC of the energy storage device is 75%, the electronic device 100 may determine the possible charge-discharge range of −25% to 75% to be the action space. The electronic device 100 may continuously control the charging and discharging of the energy storage device using the objective function that considers the possible charge-discharge range (e.g., the action space).

As described above, the electronic device 100 may control the charging and discharging of the energy storage device using a neural network (e.g., a reinforcement learning model). The neural network may be a general model that has the ability to solve a problem, where artificial neurons (nodes) forming a network through synaptic combinations change the connection strength of synapses through training.

According to an embodiment, the neurons of the neural network may include a combination of weights or biases. The neural network may include one or more layers, each including one or more neurons or nodes. The neural network may infer a desired result from a predetermined input by changing weights of the neurons through training.

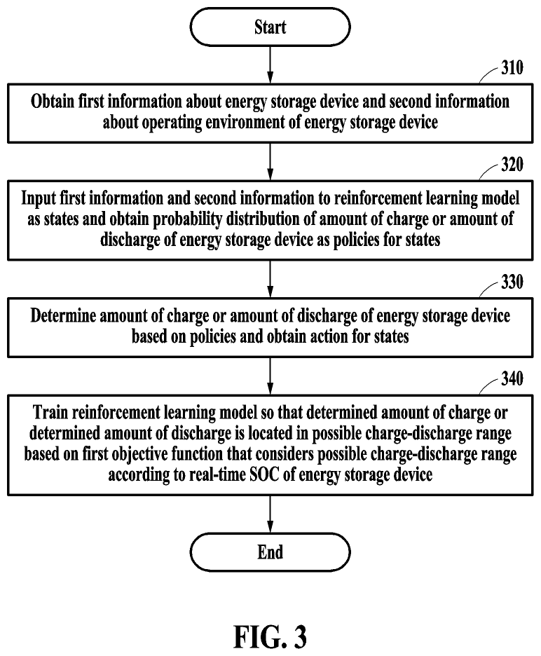

According to an embodiment, the neural network may include a deep neural network (DNN). The neural network may include a convolutional neural network (CNN), a recurrent neural network (RNN), a perceptron, a multiplayer perceptron, a feed forward (FF), a radial basis network (RBF), a deep feed forward (DFF), long short-term memory (LSTM), a gated recurrent unit (GRU), an autoencoder (AE), a variational auto encoder (VAE), a denoising auto encoder (DAE), a sparse auto encoder (SAE), a Markov chain (MC), a Hopfield network (HN), a Boltzmann machine (BM), a restricted BM (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN). The structure of the neural network (e.g., a reinforcement learning model) implemented in the electronic device 100 is described in detail below with reference to FIG. 3.

According to an embodiment, the electronic device 100 may be implemented in a personal computer (PC), a data server, or a portable device. The electronic device 100 may be implemented separately from the energy storage device to be controlled or may be implemented in the energy storage device.

According to an embodiment, the portable device may be implemented as, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may include, for example, a smartwatch, a smart band, and a smart ring.

According to an embodiment, the electronic device 100 may include a processor 110 and a memory 120.

According to an embodiment, the processor 110 may process data stored in the memory 120. The processor 110 may execute computer-readable code (e.g., software) stored in the memory 120 and instructions triggered by the processor 110.

According to an embodiment, the processor 110 may be a data-processing device implemented by hardware having a circuit that has a physical structure to execute desired operations. For example, the desired operations may include code or instructions included in a program.

According to an embodiment, the data processing device implemented by hardware may include a microprocessor, a central processing unit (CPU), a processor core, a multi-core processor, a multiprocessor, an application-specific integrated circuit (ASIC), and/or a field-programmable gate array (FPGA).

According to an embodiment, the memory 120 may be implemented as a volatile memory device or a non-volatile memory device.

According to an embodiment, the volatile memory device may be implemented as dynamic random-access memory (DRAM), static RAM (SRAM), thyristor RAM (T-RAM), zero capacitor RAM (Z-RAM), or twin transistor RAM (TTRAM).

According to an embodiment, the non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano-floating gate memory (NFGM), holographic memory, a molecular electronic memory device, or insulator resistance change memory.

FIG. 2 is a diagram illustrating a reinforcement learning model according to an embodiment.

FIG. 2 illustrates an internal configuration of a reinforcement learning model 200, according to an embodiment. The reinforcement learning model 200 may include an actor neural network 210 and a critic neural network 220.

According to an embodiment, the actor neural network 210 may output policies 202 based on a state 201. The state 201 may include first information about an energy storage device and second information about an operating environment of the energy storage device. The first information about the energy storage device may include a real-time SOC of the energy storage device. The second information about the operating environment of the energy storage device may include information about the real-time power price, information about the real-time power demand, and/or information about the real-time power supply in the operating environment of the energy storage device. The policies 202 may include a probability distribution of the amount of charge or the amount of discharge. An action 204 may be determined based on the policies 202, and the action 204 may correspond to an average value of the policies 202. The action 204 may be the amount of charge or the amount of discharge of the energy storage device.

According to an embodiment, the critic neural network 220 may output a value 203 (e.g., a value function estimate) of the state 201. The value 203 may be an estimate of rewards that may be accumulated in and obtained from the state 201. The rewards may be calculated by considering the operating environment of the energy storage device. That is, the rewards may be calculated based on the second information about the operating environment of the energy storage device. The critic neural network 220 may provide feedback on an action (e.g., the action 204) determined in the state 201. That is, the critic neural network 220 may quantify how valuable the state 201 is in terms of future rewards.

According to an embodiment, the actor neural network 210 and the critic neural network 220 are described as being implemented separately but not limited thereto, and the actor neural network 210 and the critic neural network 220 may be implemented as an integrated neural network.

FIG. 3 is a flowchart illustrating an operation of training a reinforcement learning model, according to an embodiment.

Referring to FIG. 3, according to an embodiment, operations 310 to 340 may be at least a part of an operation of training a reinforcement learning model (e.g., the reinforcement learning model 200 of FIG. 2) of an electronic device (e.g., the electronic device 100 of FIG. 1). Operations 310 to 340 may be performed sequentially but not necessarily. For example, the order of operations 310 to 340 may be changed, and at least two operations may be performed in parallel.

According to an embodiment, operations 310 to 340 may be performed by a processor (e.g., the processor 110 of FIG. 1) of the electronic device 100.

In operation 310, according to an embodiment, the electronic device 100 may obtain first information about an energy storage device and second information about an operating environment of the energy storage device. The first information may include a real-time SOC of the energy storage device. The second information may include information about the real-time power price, information about the real-time power demand, and/or information about the real-time power supply in the operating environment of the energy storage device.

In operation 320, according to an embodiment, the electronic device 100 may input the first information and the second information to the reinforcement learning model as states and may obtain a probability distribution of the amount of charge or the amount of discharge of the energy storage device as policies for the states.

In operation 330, according to an embodiment, the electronic device 100 may determine the amount of charge or the amount of discharge of the energy storage device based on the policies and may obtain an action for the states. The determined amount of charge or the determined amount of discharge may correspond to an average value of the policies.

In operation 340, according to an embodiment, the electronic device 100 may train the reinforcement learning model so that the determined amount of charge or the determined amount of discharge is located in a possible charge-discharge range based on a first objective function that considers the possible charge-discharge range according to the real-time SOC of the energy storage device. The training of the reinforcement learning model may be performed based on a second objective function for an actor neural network and a third objective function for a critic neural network in addition to the first objective function.

According to an embodiment, the electronic device 100 may first calculate a reward for the determined amount of charge or the determined amount of discharge based on the second information about the operating environment of the energy storage device. The electronic device 100 may calculate an objective function to train the reinforcement learning model based on the reward. As described above, the objective function may include the first objective function, the second objective function, and/or the third objective function. The first objective function may be expressed as shown in Equation 1 below.

$$f ( θ ) = {min ( {μ}_{θ} ( s ) - {a}_{s , min} , 0 )}^{2} + {min ( {a}_{s , max} - {μ}_{θ} ( s ) , 0 )}^{2} \qquad [ Equation 1 ]$$

In Equation 1, μ_{θ}(s) denotes an action in a state s, α_{s,min} denotes the minimum value of possible actions in the state s, α_{s,max} denotes the maximum value of the possible actions in the state s, and the action may correspond to the amount of charge or the amount of discharge. Through the first objective function, the actor neural network (e.g., the actor neural network 210 of FIG. 2) may be trained to output policies (and/or actions) existing in the possible charge-discharge range (e.g., a feasible action space).

According to an embodiment, the second objective function for the actor neural network (e.g., the actor neural network 210 of FIG. 2) may be expressed as shown in Equation 2 below.

$${∇}_{θ} J ( θ ) = {∇}_{θ} log {π}_{θ} ( a \vert s ) ( r + γ V ( {s}^{′} \vert {θ}_{v} ) - V ( s \vert {θ}_{v} ) ) \qquad [ Equation 2 ]$$

In Equation 2, π_{θ}(α|s) denotes a policy (e.g., a probability distribution of an action α) in a state s, r denotes a reward calculated based on the second information, γ denotes a discount factor, s′ denotes the next state, and V(s|θᵥ) denotes a value in the current state s. θᵥ denotes a parameter of the critic neural network. Through the second objective function, the actor neural network (e.g., the actor neural network 210 of FIG. 2) may be trained to output policies (and/or actions) that maximize a value of a state.

According to an embodiment, the third objective function for the critic neural network (e.g., the critic neural network 220 of FIG. 2) may be expressed as shown in Equation 3 below.

$$L ( {θ}_{v} ) = {( r + γ V ( {s}^{′} \vert {θ}_{v} ) - V ( s \vert {θ}_{v} ) )}^{2} \qquad [ Equation 3 ]$$

In Equation 3, r denotes a reward calculated based on the second information, γ denotes a discount factor, s′ denotes the next state, and V(s|θᵥ) denotes a value in the current state s. θᵥ denotes a parameter of the critic neural network. Through the third objective function, the critic neural network (e.g., the critic neural network 220 of FIG. 2) may be trained to minimize an error of an estimated value (and/or a value function).

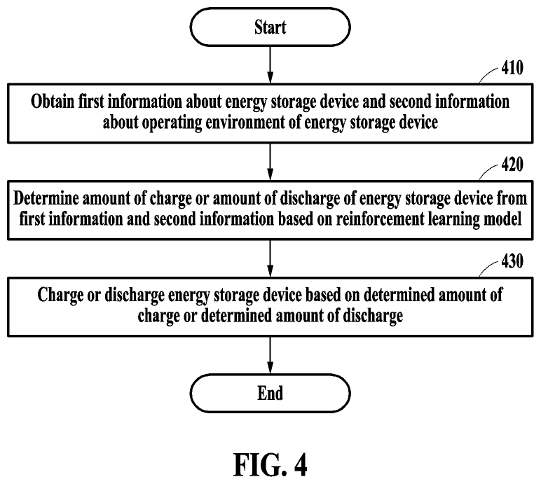

FIG. 4 is a flowchart illustrating an operation of controlling an energy storage device based on a trained reinforcement learning model, according to an embodiment.

Referring to FIG. 4, according to an embodiment, operations 410 to 430 may be at least a part of an operation of controlling an energy storage device based on a reinforcement learning model of an electronic device (e.g., the electronic device 100 of FIG. 1). Operations 410 to 430 may be performed sequentially but not necessarily. For example, the order of operations 410 to 430 may be changed, and at least two operations may be performed in parallel.

According to an embodiment, operations 410 to 430 may be performed by a processor (e.g., the processor 110 of FIG. 1) of the electronic device 100.

In operation 410, according to an embodiment, the electronic device 100 may obtain first information about the energy storage device and second information about an operating environment of the energy storage device.

In operation 420, according to an embodiment, the electronic device 100 may determine the amount of charge or the amount of discharge of the energy storage device from the first information and the second information based on a trained reinforcement learning model. The trained reinforcement learning model may be trained based on a first objective function that considers a possible charge-discharge range according to a real-time SOC of the energy storage device (e.g., see Equation 1).

In operation 430, according to an embodiment, the electronic device 100 may charge or discharge the energy storage device based on the determined amount of charge or the determined amount of discharge.

According to an embodiment, the electronic device 100 may continuously control the charging and discharging of the energy storage device. The electronic device 100 may use an objective function (e.g., the first objective function) that considers the possible charge-discharge range according to the real-time SOC of the energy storage device. For example, when the real-time SOC of the energy storage device is 75%, the electronic device 100 may determine the possible charge-discharge range of −25% to 75% to be an action space. The electronic device 100 may continuously control the charging and discharging of the energy storage device using the objective function that considers the possible charge-discharge range (e.g., the action space).

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

Software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as floptical disks; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method comprising:
obtaining first information about an energy storage device and second information about an operating environment of the energy storage device;
determining an amount of charge or an amount of discharge of the energy storage device from the first information and the second information based on a reinforcement learning model;
charging or discharging the energy storage device based on the determined amount of charge or the determined amount of discharge,
wherein the reinforcement learning model is trained based on a first objective function that considers a possible charge-discharge range according to a real-time state of charge (SOC) of the energy storage device.

2. The method of claim 1, wherein
the first information comprises the real-time SOC of the energy storage device, and
the second information comprises at least one of information about a real-time power price, information about a real-time power demand, or information about a real-time power supply in the operating environment.

3. The method of claim 1, wherein the reinforcement learning model comprises:
an actor neural network configured to receive the first information and the second information as states and configured to output a probability distribution of the amount of charge or the amount of discharge as policies for the states; and
a critic neural network configured to evaluate a value of the states.

4. The method of claim 3, wherein the amount of charge or the amount of discharge is obtained by averaging the policies and corresponds to an action of the reinforcement learning model.

5. The method of claim 3, wherein the reinforcement learning model is trained based on the first objective function, a second objective function for the actor neural network, and a third objective function for the critic neural network.

6. The method of claim 1, wherein the first objective function satisfies a following Equation,
$$f ( θ ) = {min ( {μ}_{θ} ( s ) - {a}_{s , min} , 0 )}^{2} + {min ( {a}_{s , max} - {μ}_{θ} ( s ) , 0 )}^{2}$$
wherein μ_{θ}(s) denotes an action in a state s, α_{s,min} denotes a minimum value of possible actions in the state s, and α_{s,max} denotes a maximum value of the possible actions in the state s, wherein the action is the amount of charge or the amount of discharge.

7. A non-transitory computer-readable storage medium storing instructions that, when executed by a processor, cause the processor to perform the method of claim 1.

8. An electronic device comprising:
a processor; and
a memory configured to store instructions,
wherein the instructions, when executed by the processor, cause the electronic device to:
obtain first information about an energy storage device and second information about an operating environment of the energy storage device;
determine an amount of charge or an amount of discharge of the energy storage device from the first information and the second information based on a reinforcement learning model; and
charge or discharge the energy storage device based on the determined amount of charge or the determined amount of discharge,
wherein the reinforcement learning model is trained based on a first objective function that considers a possible charge-discharge range according to a real-time state of charge (SOC) of the energy storage device.

9. The electronic device of claim 8, wherein
the first information comprises the real-time SOC of the energy storage device, and
the second information comprises at least one of information about a real-time power price, information about a real-time power demand, or information about a real-time power supply in the operating environment.

10. The electronic device of claim 8, wherein the reinforcement learning model comprises:
an actor neural network configured to receive the first information and the second information as states and configured to output a probability distribution of the amount of charge or the amount of discharge as policies for the states; and
a critic neural network configured to evaluate a value of the states.

11. The electronic device of claim 10, wherein the amount of charge or the amount of discharge is obtained by averaging the policies and corresponds to an action of the reinforcement learning model.

12. The electronic device of claim 10, wherein the reinforcement learning model is trained based on the first objective function, a second objective function for the actor neural network, and a third objective function for the critic neural network.

13. The electronic device of claim 8, wherein the first objective function satisfies a following Equation,
$$f ( θ ) = {min ( {μ}_{θ} ( s ) - {a}_{s , min} , 0 )}^{2} + {min ( {a}_{s , max} - {μ}_{θ} ( s ) , 0 )}^{2}$$
wherein μ_{θ}(s) denotes an action in a state s, α_{s,min} denotes a minimum value of possible actions in the state s, and α_{s,max} denotes a maximum value of the possible actions in the state s, wherein the action is the amount of charge or the amount of discharge.

14. A method comprising:
obtaining first information about an energy storage device and second information about an operating environment of the energy storage device;
by inputting the first information and the second information to a reinforcement learning model as states, obtaining a probability distribution of an amount of charge or an amount of discharge of the energy storage device as policies for the states;
obtaining an action for the states by determining the amount of charge or the amount of discharge of the energy storage device based on the policies; and
based on a first objective function that considers a possible charge-discharge range according to a real-time state of charge (SOC) of the energy storage device, training the reinforcement learning model so that the determined amount of charge or the determined amount of discharge is located in the possible charge-discharge range.

15. The method of claim 14, wherein
the first information comprises the real-time SOC of the energy storage device, and
the second information comprises at least one of information about a real-time power price, information about a real-time power demand, or information about a real-time power supply in the operating environment.

16. The method of claim 15, wherein the training of the reinforcement learning model comprises:
calculating a reward for the determined amount of charge or the determined amount of discharge based on the second information; and
calculating an objective function to train the reinforcement learning model based on the reward.

17. The method of claim 16, wherein the reinforcement learning model comprises:
an actor neural network configured to output the policies for the states; and
a critic neural network configured to evaluate a value of the states,
wherein the objective function comprises the first objective function, a second objective function for the actor neural network, and a third objective function for the critic neural network.

18. The method of claim 17, wherein the first objective function satisfies a following Equation,
$$f ( θ ) = {min ( {μ}_{θ} ( s ) - {a}_{s , min} , 0 )}^{2} + {min ( {a}_{s , max} - {μ}_{θ} ( s ) , 0 )}^{2}$$
wherein μ_{θ}(s) denotes an action in a state s, α_{s,min} denotes a minimum value of possible actions in the state s, α_{s,max} denotes a maximum value of the possible actions in the state s, wherein the action is the amount of charge or the amount of discharge.

19. The method of claim 17, wherein the determined amount of charge or the determined amount of discharge corresponds to an average value of the policies.
